(19) United States
(12) Patent Application Publication
(10) Pub. No.: US 2019/0268371 A1
(43) Pub. Date: Aug. 29, 2019

(54) SYSTEMS AND METHODS FOR IDENTIFYING A HACKED DATA COMMUNICATION RECEIVED BY AN UNMANNED VEHICLE

(71) Applicant: Walmart Apollo, LLC, Bentonville, AR (US)

(72) Inventors: Donald R. High, Noel, MO (US); David C. Winkle, Bella Vista, AR (US); John J. O'Brien, Farmington, AR (US); Robert L. Cantrell, Herndon, VA (US); Todd D. Mattingly, Bentonville, AR (US)

(21) Appl. No.: 16/272,385

(22) Filed: Feb. 11, 2019

Related U.S. Application Data
(60) Provisional application No. 62/634,398, filed on Feb. 23, 2018.

(51) Int. Cl. H04L 29/06; B64C 39/02; H04B 17/318; H04W 4/80

(52) U.S. Cl. CPC H04L 63/1466; H04L 63/1416; B64C 2201/128; H04B 17/318; H04W 4/80; B64C 39/024

(57) ABSTRACT

In some embodiments, apparatuses and methods are provided herein useful to identifying a hacked data communication received by an unmanned vehicle (UV). In some embodiments, there is provided a system for identifying a hacked data communication received by a UV including a retail UV a first antenna; a second antenna; a timing device; a memory device; a transport device; and a control circuit configured to determine whether data communication is hacked based on at least: an estimated location of a signal source, a determined timestamp, a determined source device identifier, a determined data type of a data content, and a source antenna; and in response to a determination that the data communication is not hacked, modify a first mission data to a second mission data; and initiate operation of the transport device to move the UV through a modified route based on the second mission data.

### CROSS-REFERENCE TO RELATED APPLICATION

This application claims the benefit of U.S. Provisional Application No. 62/634,398 filed Feb. 23, 2018, which is incorporated herein by reference in its entirety.

### TECHNICAL FIELD

This invention relates generally to identifying a hacked data communication.

### BACKGROUND

Generally, a user who is flying an unmanned vehicle (UV) is a short distance away from the UV. The UV is always within the user's eyesight. In general, data communications are exchanged between the UV and the user via a handheld controller.

### BRIEF DESCRIPTION OF THE DRAWINGS

Disclosed herein are embodiments of systems, apparatuses and methods pertaining to identifying a hacked data communication received by an unmanned vehicle. This description includes drawings, wherein:

FIG. 1 illustrates a simplified block diagram of an exemplary system for identifying a hacked data communication received by an unmanned vehicle in accordance with some embodiments;

FIG. 2 shows a flow diagram of an exemplary process of identifying a hacked data communication received by an unmanned vehicle in accordance with some embodiments;

FIG. 3 is a continuation of the exemplary process depicted in FIG. 2; and

FIG. 4 illustrates an exemplary system for use in implementing methods, techniques, devices, apparatuses, systems, servers, sources and monitoring item distribution, in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein useful for identifying a hacked data communication received by an unmanned vehicle. In some embodiments, a retail system for identifying a hacked data communication received by an unmanned vehicle while delivering a purchased product includes a retail unmanned vehicle (UV) including a first antenna that may receive a first signal in accordance with a first network communication protocol. By one approach, the retail UV (or the UV) may include a second antenna that may receive a second signal in accordance with a second network communication protocol. By another approach, the UV may include a timing device that may provide a timestamp on the receipt of at least one of: the first signal and the second signal. By another approach, the system may include a memory device that may store a first mission data associated with the UV. By another approach, the system may include a transport device that may move the UV through a predetermined route based on the first mission data. By yet another approach, the system may include a control circuit that may communicatively couple to the first antenna, the second antenna, the timing device, the memory device, and/or the transport device. In one configuration, the control circuit may determine data communication and source antenna associated with the data communication based on at least one of: the first signal received by the first antenna and the second signal received by the second antenna. In another configuration, the control circuit may determine the signal direction of at least one of: the first signal and the second signal based on corresponding signal strength. In another configuration, the control circuit may estimate a location of a signal source of at least one of: the first signal and the second signal based on the determined signal direction. In another configuration, the control circuit may determine, in cooperation with the timing device, the timestamp corresponding to a receipt of at least one of: the first signal and the second signal. In another configuration, the control circuit may determine a source device identifier based on data content of the data communication. In another configuration, the control circuit may determine the data type of the data content. In another configuration, the control circuit may determine whether the data communication is hacked based on at least: the estimated location of the signal source, the determined timestamp corresponding to the receipt, the determined source device identifier, the determined data type, and the source antenna. In yet another configuration, the control circuit may, in response to the determination that the data communication is not hacked, modify the first mission data to a second mission data based on the data content. By one approach, the control circuit may initiate operation of the transport device to move the UV through a modified route based on the second mission data.

In some embodiments, a method for identifying a hacked data communication received by an unmanned vehicle while delivering a purchased product includes determining data communication and source antenna associated with the data communication based on at least one of: first signal received by a first antenna of an unmanned vehicle (UV) and second signal received by a second antenna of the UV. In one configuration, the method may include determining the signal direction of at least one of: the first signal and the second signal based on corresponding signal strength. In another configuration, the method may include estimating a location of a signal source of at least one of: the first signal and the second signal based on the determined signal direction. In another configuration, the method may include determining, in cooperation with a timing device of the UV, a timestamp corresponding to receiving at least one of: the first signal and the second signal. In another configuration, the method may include determining a source device identifier based on data content of the data communication. In another configuration, the method may include determining the data type of the data content. In another configuration, the method may include determining whether the data communication is hacked based on at least: the estimated location of the signal source; the determined timestamp corresponding to the receipt, the determined source device identifier, the determined data type, and the source antenna. In yet another configuration, the method may include, in response to the determination that the data communication is not hacked, modifying a first mission data stored in a memory device of the UV to a second mission data based on the data content. In yet another configuration, the method may include initiating operation of a transport device of the UV to move the UV through a modified route based on the second mission data.

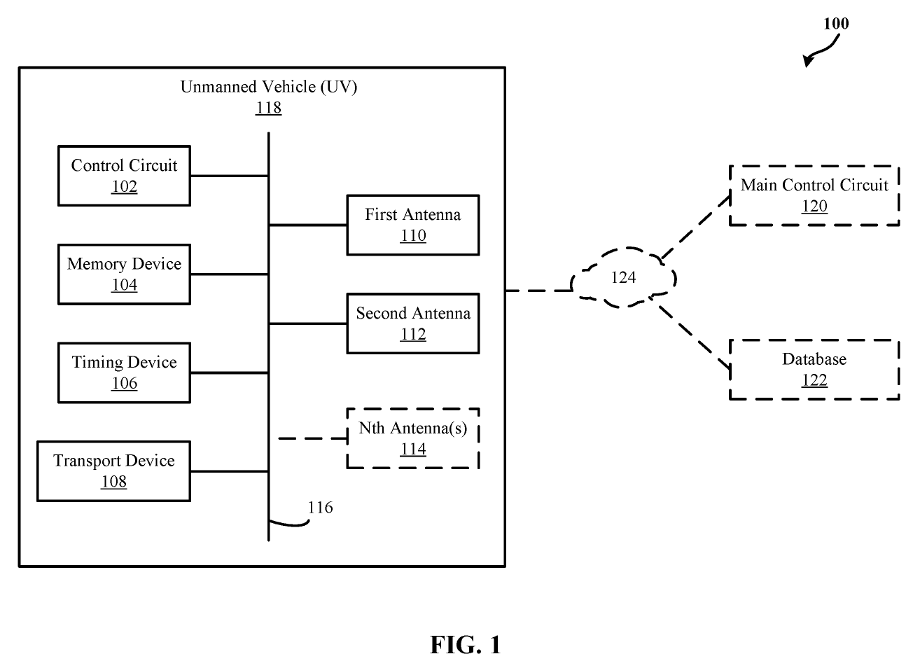

FIG. 1 illustrates a simplified block diagram of an exemplary system 100 for identifying a hacked data communication received by an unmanned vehicle in accordance with some embodiments. The system 100 includes an unmanned vehicle (UV) 118 that identifies a hacked data communication received by the UV 118 while delivering a purchased product. By one approach, the UV 118 may include one or more antennas (e.g., the first antenna 110, the second antenna 112, through the Nth antenna(s) 114). In one example, the one or more antennas may be configured to receive and/or transmit a particular range of frequencies in a radio spectrum. In some embodiments, the UV 118 may include one or more transmitters, receivers, and/or transceivers corresponding to the one or more antennas. The UV 118 may include one or more timing devices 106, one or more memory devices 104, and one or more transport devices 108. Further, the UV 118 includes a control circuit 102. In one configuration, the control circuit 102 may communicatively couple to the one or more antennas (e.g., first antenna 110, the second antenna 112, the Nth antenna(s) 114), the timing device 106, the memory device 104, and/or the transport device 108 via one or more communication buses 116. In another configuration, the UV 118 may communicatively couple with a main control circuit 120, a database 122, an inventory system, an inventory system, a third-party electronic system, an ordering system, delivery route system, and/or other electronic systems (or computer systems) associated with retail stores via one or more communication networks 124. In one example, a communication network 124 may include a cellular network, a WiFi network, an internet, a Local Area Network, a Wide Area Network, a blockchain network, among other types of networks configured to facilitate communication medium between one electronic device to one or more electronic devices.

By another approach, the control circuit 102 may determine data communication and corresponding source antenna of the data communication based on a first signal received by the first antenna 110 and/or a second signal received by the second antenna 112. For example, the first antenna 110 may receive and/or transmit a first signal that is in accordance with a first network communication protocol (or standard). In another example, the second antenna may receive and/or transmit the second signal that is in accordance with a second network communication protocol (or standard). In another example, the first network communication protocol may be distinct from the second network communication protocol. For example, the network communication protocols (or standards), including the first and second network communication protocols, may include Long Term Evolution (LTE), 4G, 3G, WiFi, Local Area Network, Wide Area Network, Bluetooth, WirelessHD, WiGig, Z-Wave, Zigbee, among other type of communication protocols/standards that are used by one electronic device to communicate wirelessly with another electronic device, such as the UV 118. Typically, at a given time or over a given period of time the first network communication protocol is different and distinct from the second network communication protocol. In one example, each retail store associated with the UV 118 may be assigned a particular network communication protocol. In another example, retail stores associated with a particular neighborhood or area may be assigned a particular network communication protocol. In such an example, the control circuit 102 may determine and/or estimate that a data communication received by the UV 118 is associated with a particular retail store based on a network communication protocol associated with the data communication and/or a corresponding antenna that received a signal associated with the data communication. In an illustrative non-limiting example, the first antenna 110 of the UV 118 may be configured to receive a first signal associated with a first network communication protocol (e.g., WiFi) while the second antenna 112 of the UV 118 may be configured to receive a second signal associated with a second network communication protocol (e.g., cellular). Continuing the example, a first retail store may be assigned to communicate with the UV 118 (and/or other UVs based on predetermined assignments and/or distance from the first retail store) using the first network communication protocol while a second retail store may be assigned to communicate with the UV 118 using (and/or other UVs based on predetermined assignments and/or distance from the second retail store) the second network communication protocol. By one example, when the UV 118 receives the first signal via the first antenna, the control circuit 102 may process the first signal and, based on the processing of the first signal, determine that the data communication associated with the first signal is associated with the second retail store. In response, the control circuit 102 may access a plurality of predefined associations stored in the memory device 104 and/or the database 122 to determine whether a data communication with the second retail store is expected to be received at the first antenna. For example, the memory device 104 and/or the database 122 may store a confidence marker value and/or a plurality of associations comprising a first association of each of a plurality of neighborhood areas with one or more of a plurality of retail stores associated with the UV, a second association of each of a plurality of source device identifiers with one or more of the plurality of retail stores, a third association of each of the plurality of retail stores with one or more of a plurality of network communication protocols, and a fourth association of each of a plurality of data types with one or more of a plurality of time periods. In one scenario, the plurality of associations may correspond to predefined associations that are periodically downloaded from the main control circuit 120 to the memory device 104 and/or the database 122. In another scenario, the predefined associations may be downloaded in conjunction with or downloaded within a proximate time as mission data is downloaded prior to a start of a delivery of the UV 118. In another example, the confidence marker value may be initially set to a predefined value prior to a start of a delivery of retail products by the UV 118. By one approach, the mission data may include the confidence marker value that is initially set to the predefined value when the mission data is initially downloaded to the memory device 104. By another approach, the confidence marker value may instead be set to the predefined value at the end of each delivery of retail products to a delivery destination. In one example, the data communication may correspond to a demodulated signal of at least one of: the first signal and the second signal. By one approach, the control circuit 102 may perform signal processing of a signal received from one of the antennas 110, 112, 114.

In another illustrative non-limiting example, if the first signal is received at the first antenna 110 and the control circuit 102 determines that data communication associated with the first signal includes information associated with the first retail store and, on a subsequent access to the plurality of associations stored in the memory device 104 and/or the database 122, the control circuit 102 determines that a signal associated with the first retail store is expected to be received at the first antenna 110, the control circuit 102 may determine that there is a match. As such, the control circuit 102 may initially determine that the data communication is not hacked, meaning, the data communication may have originated from a legitimate and/or trusted source that is associated with the UV 118. Alternatively or in addition to, when the control circuit 102 determines that a signal associated with the first retail store is not expected to be received at the first antenna 110, the control circuit 102 may determine that there is a mismatch. In response, the control circuit 102 may initially determine that the received data communication is hacked.

In one configuration, the control circuit 102 may determine a signal direction of the first signal and/or the second signal based on corresponding signal strength. For example, the control circuit 102 may perform signal processing of the first signal and/or the second signal to determine a spatial direction of one or more signals that have higher received signal strength (or signal power) relative to the rest of the signals received by the antennas 110, 112, 114 over a period of time (e.g., a span of seconds, minutes, and/or hours). In an illustrative non-limiting example, in response to processing the first signal and/or the second signal, the control circuit 102 may determine that signals that have a signal strength that is within a threshold are received from a Northeast direction of the UV 118. In one configuration, the control circuit 102 may estimate a location of a signal source of the first signal and/or the second signal based on the determined signal direction. In one configuration, the control circuit 102 may further perform a subsequent signal processing of the first signal and/or the second signal to estimate a location of a source of the first signal and/or the second signal based on the determined signal direction. Continuing the illustrative non-limiting example above, the control circuit 102 may access the memory device 104 and/or the database 122 communicatively coupled with the memory device 104, the control circuit 102, and/or the main control circuit 120 to determine whether one or more retail stores associated with the UV 118 are located in one or more areas and/or neighborhoods that are towards the determined signal direction. In response to the determination that a retail store associated with the UV 118 is located towards the determined signal direction, the control circuit 102 may estimate the location of a signal source of a signal received from one of the antennas 110, 112, 114. Alternatively or in addition to, in estimating a location of the signal source, the control circuit 102 may determine a particular neighborhood area of a plurality of neighborhood areas the UV 118 is currently located. By one approach, the control circuit 102 may determine a navigational positioning coordinate of the UV 118 (e.g., Global Positioning Satellite (GPS) location coordinate, or the like) and use the navigational positioning coordinate to determine if one or more of the plurality of neighborhood areas associated with the retail store are within a threshold distance of the navigational positioning coordinate. Alternatively or in addition to, the control circuit 102 may correlate the signal direction with the determined particular neighborhood area based on signal strength to estimate the location of the source of the signal. Alternatively or in addition to, the control circuit 102 may determine a confidence value that the estimated location corresponds to a retail store of a plurality of retail stores associated with the UV 118. By one approach, the control circuit 102 may determine the confidence value based on how strong the signal strength of a corresponding signal (the first signal or the second signal) relative to one or more predetermined thresholds. In such an approach, the determined confidence value may vary over a period of time based on the UV's 118 location relative to the signal direction as the UV 118 moves through a delivery route. By another approach, the determined confidence value may be based on an average of the signal strength of the corresponding signal over the period of time. By another approach, the control circuit 102 may determine a confidence value for a predetermined period of time (e.g., within a particular time duration that the UV 118 takes to travel a particular distance and/or travel across a particular neighborhood or area). For example, based on the correlation, the control circuit 102 may determine that a retail store associated with the UV 118 is estimated to be the source of the signal received by one of the antennas 110, 112, 114 and the accuracy of the estimate may correspond to a particular confidence value. In such an example, the memory device 104 may store a plurality of predetermined thresholds used by the control circuit 102 to aid in automatically making a decision. For example, in response to a determination that the confidence value has reached a second threshold of the plurality of predetermined thresholds, the control circuit 102 may increase a confidence marker value. In such an example, with the confidence value reaching the second threshold, the control circuit 102 may determine to have an acceptable confidence that a retail store associated with the UV 118 is located in the direction of the source signal of the signal received from one of the antennas 110, 112, 114. In addition to the plurality of predetermined thresholds, the memory device 104 may store the confidence marker value.

By one approach, the confidence marker value may be used by the control circuit 102 to determine whether the data communication received by the UV 118 is hacked. For example, the control circuit 102 may determine whether the confidence marker value has reached a first threshold of the plurality of predetermined thresholds. Alternatively or in addition to, in response to the determination that the confidence marker value has reached the first threshold, the control circuit 102 may determine that the data communication is not hacked. Alternatively or in addition to, in response to the determination that the confidence marker value did not reach the first threshold, the control circuit 102 may determine that the data communication is hacked.

In some embodiments, the memory device 104 and/or the database 122 may store a response matrix. In one configuration, the response matrix may identify a plurality of UV responses corresponding to a plurality of confidence marker values and a plurality of estimated locations of signal sources; a plurality of timestamps corresponding to receipts of signals, a plurality of source device identifiers, a plurality of data types, and/or a plurality of network communication protocols associated with a source antenna. In such a configuration, the control circuit 102 may, in response to the determination that the confidence marker value did not reach the first threshold, the control circuit 102 may access the response matrix to determine a UV response of the plurality of UV responses operable by the UV 118.

In an illustrative non-limiting example, during a delivery of a retail product, the UV 118 may receive a signal at the first antenna 110 configured for receiving signals associated with a particular network communication protocol. In determining that a data communication associated with the signal is hacked, the control circuit 102 may have performed a confidence criteria test and determined at least the following: that an estimated location of a source of the signal may not correspond to a neighborhood or an area where a retail store associated with the UV 118 may be located; however, a timestamp associated with the receipt of the signal corresponds to a time that the control circuit 102 expects to receive a data type (e.g., instruction) associated with the data communication; that the first antenna received the signal purported to be from a retail store assigned to communicate with the UV 118 using the particular network communication protocol; and that a source device identifier associated with the data communication corresponds to the retail store assigned to communicate with the UV 118 using the particular network communication protocol. In response to the data communication not passing a confidence criteria, as previously illustrated, the control circuit 102 may determine that the data communication is hacked. Alternatively or in addition to, the control circuit 102 may subsequently access the response matrix stored in the memory device 104 and/or the database 122. In one example, the control circuit 102 may access the response matrix to determine whether one or more UV responses are to be executed or performed by the UV 118 in response to a result of the confidence criteria test. In one configuration, the response matrix may store a plurality of UV responses, where each UV response is associated with a particular combination of failure and/or passing of each confidence criteria in the confidence criteria test. As such, continuing the illustrative non-limiting example above, the control circuit 102 may search in the response matrix for a UV response corresponding to a failure of a first confidence criteria associated with estimating location of a source of a signal and passing of the remaining confidence criteria (e.g., whether a timestamp associated with a received signal corresponds with a time expected to receive a data type associated with data communication corresponding to the received signal, whether an antenna associated with a network communication protocol received a signal from a retail store that is purported to be a retail store associated with a UV 118 based on the UV 118 associated retail store's assignment to use the network communication protocol to communicate with the UV 118, and whether a source device identifier associated with the data communication corresponds to the UV 118 associated retail store's corresponding source device identifier). By one approach, additional confidence criteria may be included in the confidence criteria test to further narrow down or filter down a search for the UV response in the response matrix. In such an approach, the response matrix may store combinations of passing and/or failure of each of the additional confidence criteria and associate each combination criteria to a particular UV response of the plurality of UV responses.

Alternatively or in addition to, the control circuit 102 may determine, via the access to the response matrix, the UV response corresponding to the confidence marker value and the estimated location of the signal source, the determined timestamp corresponding to the receipt, the determined source device identifier, the determined data type, and/or the receiving antenna source associated with the data communication. For example, in determining that a confidence marker value did not reach a particular threshold, the control circuit 102 may determine a particular UV response to be executed by the UV 118 in response to receiving a possible hacked data communication. By one approach, the control circuit 102 may access the memory device 104 and/or the database 122 to determine which UV response is associated with a presence and/or absence and/or corresponding values of the following: the confidence marker value, the estimated location of a signal source of a signal, the determined timestamp corresponding to receipt of the signal, the determined source device identifier of data communication associated with the signal, the determined data type of the data communication, and/or the receiving antenna source associated with the data communication. For example, the UV response of the UV 118 may include returning home, detour to a secure site, follow command included in the received data communication, initiate communication with the main control circuit 120, initiate download or storage of data information, among other possible responses that a UV may execute in response to determining that a received data communication may be hacked.

Alternatively or in addition to, the control circuit 102 may, in response to a determination that one or more data communications are hacked, initiate storage to the memory device 104 of the estimated location of the signal source, the determined timestamp corresponding to the receipt of the signal, the determined source device identifier, the determined data type, and/or the source antenna associated with the data communication. By one approach, the control circuit 102, in response to the determination that the data communication is hacked, may determine one or more patterns based on the information corresponding to hacked data communication stored over a period of time in the memory device 104. For example, the control circuit 102 may determine by processing information associated with previously stored hacked data communications using known data processing techniques to determine patterns in electronically stored data. In one example, the determined patterns may include multiple occurrences of determined hacked data communication being associated with a particular location, a particular source device identifier, a particular timestamp, a particular data type, a particular combination of timestamp and data type, a particular network communication protocol, and/or a particular antenna, a particular retail store, among other patterns that may be determined based on repetition of one or more occurrences and/or events.

In some embodiments, the control circuit 102, in response to the determination that the data communication is hacked, may continue operating the transport device 108 to move the UV 118 through a predetermined route. In other words, in response to a determination that the data communication is hacked, the UV 118 may maintain the predetermined route associated with a mission data initially received prior to a start of delivery by the UV 118. As such, the received data communication determined to be a hacked communication is ignored by the UV 118. For example, the mission data may correspond to a first mission data stored in the memory device 104. In another example, the memory device 104 may store a subsequent mission data provided by the main control circuit 120 to the UV 118 in response to a change in a delivery route and/or retail products to be delivered.

In some embodiments, the control circuit 102 may determine, in cooperation with the timing device 106, a timestamp corresponding to a receipt of a first signal received by the first antenna 110 and/or a second signal received by the second antenna 112. By one approach, the timing device 106 may provide a timestamp when the first signal and/or the second signal is received by the corresponding antenna 110, 112. For example, the control circuit 102 may receive the timestamp corresponding to the received signal from the corresponding antenna 110, 112 at substantially the same time or within a threshold of time apart. By another approach, the control circuit 102 or the corresponding receivers and/or transceivers may process the received signal to a data communication operable and/or usable by the control circuit 102 and/or the UV 118. In one configuration, the data communication may include one or more data contents, where at least one of the data contents include a source device identifier and/or an indication of a data type associated with the data contents. In one example, the control circuit 102 may determine a source device identifier based on data content of a data communication corresponding to the signal received at one of the antennas 110, 112, 114. By one approach, the source device identifier may include MAC id, a serial number, an IP address of a transmitting electronic device, among other types of identification data corresponding to an electronic device that originally sent the data communication and/or wireless signal. By another approach, the control circuit 102 may determine the data type of the data content of the received data communication. In such an approach, the control circuit 102 determines the data type based on the indication of the data type included in the data content. In one example, the data type may include command data, status data, delivery payload data, among other types of data configured to facilitate communication and/or operation of the UV 118 with another UV, a server, and/or the main control circuit 120 remote from the UV 118.

In some embodiments, the control circuit 102 may determine whether data communication corresponding to the signal received by one of the antennas 110, 112, 114 is hacked based at least partially on an estimated location of a signal source of the signal, a determined timestamp corresponding to the receipt of the signal, a determined source device identifier associated with the data communication, a determined data type of data content associated with the data communication, and which of the antennas 110, 112, 114 received the signal (e.g., the source antenna). For example, the memory device 104 may store a plurality of expected times the UV 118 expects to receive a data communication. By one approach, each of the plurality of expected times may correspond to a time range that is within a time threshold value. By another approach, the memory device 104 may store a corresponding one or more data types for each of the plurality of expected times that the UV 118 expects to receive a data communication. As such, when the control circuit 102 determines that the UV 118 received a data communication from one of the antennas 110, 112, 114, the control circuit 102 may determine whether a timestamp associated with the received data communication corresponds to one of the plurality of expected times that the UV 118 expects to receive a data communication. Additionally, the control circuit 102 may determine whether the data content of the received data communication corresponds to a type of data the UV 118 expects to receive during a time corresponding to the timestamp. For example, the control circuit 102 may determine whether a determined timestamp corresponding to a receipt of a signal is within a first time period of a plurality of time periods (e.g., the plurality of expected times the UV 118 expects to receive a data communication) associated with a determined data type based on the fourth association stored at the memory device 104. In another example, in response to the determination that the determined timestamp corresponding to the receipt is within the first time period, the control circuit 102 may increase a confidence marker value. Additionally, the control circuit 102 may determine whether the source device identifier associated with the data content is one of a plurality of source device identifiers of one or more retail stores associated with the UV 118. For example, the control circuit 102 may determine whether a determined source device identifier is a particular source device identifier associated with a retail store based on the second association stored at the memory device 104. In another example, the control circuit 102 may, in response to the determination that the determined source device identifier is the particular source device identifier associated with the retail store, the control circuit 102 may increase a confidence marker value. By one approach, when the source device identifier is determined to be associated with one of the retail stores, the control circuit 102 may determine whether the retail store associated with the source identifier is located in one of the neighborhood areas estimated to be the location of where the signal source was transmitted. In yet another approach, the control circuit 102 may determine whether a network communication protocol associated with the received signal corresponds to a particular network communication protocol associated with the retail store. For example, when the UV 118 is within a proximate distance from the retail store, any communication to the UV 118 that originates from the retail store is expected by the UV 118 to be via a WiFi communication. Thus, a data communication purporting to be from the retail store but received by the UV 118 via a cellular communication may be determined by the control circuit 102 to be potentially a hacked data communication. In such an example, the control circuit 102 may determine whether a particular network communication protocol of a plurality of network communication protocols may correspond to an expected communication protocol associated with the retail store based on the third association stored at the memory device 104. In another example, in response to the determination that the particular network communication protocol corresponds to the expected communication protocol, the control circuit 102 may increase a confidence marker value. Alternatively or in addition to, the control circuit 102 may, in response to the determination that the data communication is not hacked, modify a first mission data to a second mission data based on the data content of the received data communication. Alternatively or in addition to, the control circuit 102 may initiate operation of the transport device 108 to move the UV 118 through a modified route based on the second mission data. In one example, at the start of the delivery, the transport device 108 is configured to move the UV 118 through a predetermined route based on a first mission data initially received by the UV 118 prior to the start of the delivery.

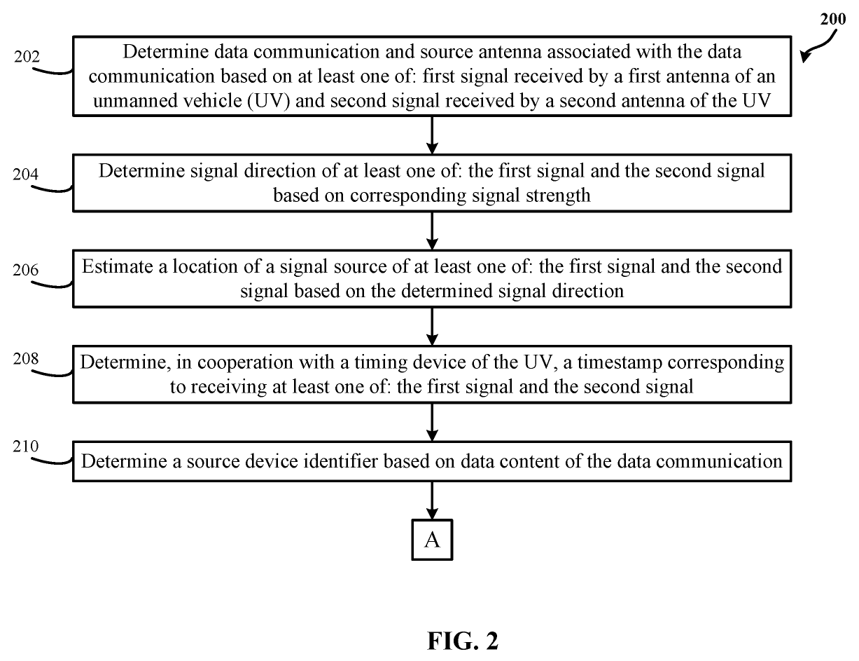

FIG. 2 illustrates a flow diagram of an exemplary method 200 identifying a hacked data communication received by an unmanned vehicle in accordance with some embodiments. The exemplary method 200 may be implemented in the system 100 of FIG. 1. One or more steps in the method 200 may be implemented in the control circuit 102 of FIG. 1. The method 200 includes, at step 202, determining data communication and source antenna associated with the data communication based on at least one of: the first signal received by a first antenna of an unmanned vehicle (UV) and a second signal received by a second antenna of the UV. By one approach, the method 200 may include, at step 204 determining the signal direction of at least one of: the first signal and the second signal based on corresponding signal strength. By another approach, the method 200 may include estimating a location of a signal source of at least one of: the first signal and the second signal based on the determined signal direction, at step 206. By another approach, the method 200 may include, at step 208, determining, in cooperation with a timing device of the UV, a timestamp corresponding to receiving at least one of: the first signal and the second signal. By another approach, the method 200 may include, at step 210, determining a source device identifier based on data content of the data communication.

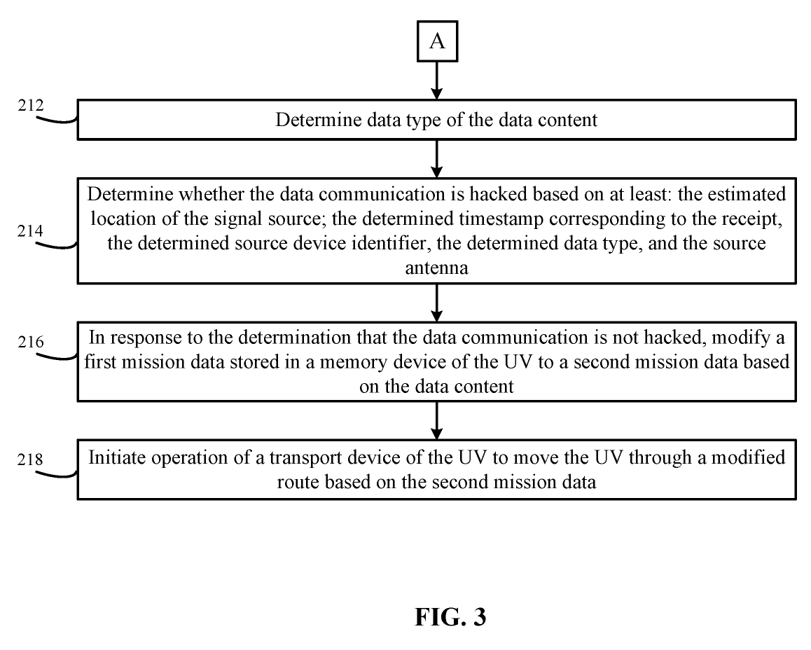

In some embodiments, FIG. 3 illustrates a flow diagram depicting one or more steps that may be additionally included in the exemplary method 200 of FIG. 2. For example, the method 200 may include, at step 212, determining the data type of a data content. In one configuration, the method 200 may include, at step 214, determining whether data communication is hacked based on at least: an estimated location of a signal source; a determined timestamp corresponding to a receipt of at least one of: a first signal and a second signal, a determined source device identifier, a determined data type of the data content, and a source antenna. In another configuration, the method 200 may include, at step 216, in response to the determination that the data communication is not hacked, modifying a first mission data stored in a memory device of a UV to a second mission data based on the data content. In another configuration, the method 200 may include initiating operation of a transport device of the UV to move the UV through a modified route based on the second mission data, at step 218.

In some embodiments, the method 200 may include storing, by a memory device, a confidence marker value and a plurality of associations comprising a first association of a plurality of neighborhood areas with a plurality of retail stores associated with the UV, a second association of a plurality of source device identifiers with the plurality of retail stores, a third association of the plurality of retail stores with a plurality of network communication protocols, and a fourth association of a plurality of data types with a plurality of time periods. By one approach, the method 200 may include determining whether the confidence marker value has reached a first threshold. In one configuration, the method 200 may include, in response to the determination that the confidence marker value has reached the first threshold, determining that the data communication is not hacked. In another configuration, the method 200 may include, in response to the determination that the confidence marker value did not reach the first threshold, determining that the data communication is hacked. By another approach, the method 200 may include, in the estimating of the location of the signal source, determining a particular neighborhood area of the plurality of neighborhood areas the UV is currently located. In one configuration, the method may include correlating the signal direction with the determined particular neighborhood area to estimate the location. In another configuration, the method 200 may include determining a confidence value that the estimated location corresponds to a retail store of the plurality of retail stores associated with the UV. In another configuration, the method may include, in response to a determination that the confidence value has reached a second threshold, increasing the confidence marker value.

Alternatively or in addition to, the method 200 may include determining whether a particular network communication protocol of the plurality of network communication protocols corresponds to an expected communication protocol associated with the retail store based on the third association. In one configuration, the method 200 may include, in response to the determination that the particular network communication protocol corresponds to the expected communication protocol, increasing the confidence marker value. Alternatively or in addition to, the method 200 may include determining whether the determined timestamp corresponding to the receipt is within a first time period of the plurality of time periods associated with the determined data type based on the fourth association. In one configuration, the method 200 may include, in response to the determination that the determined timestamp corresponding to the receipt is within the first time period, increasing the confidence marker value. Alternatively or in addition to, the method 200 may include determining whether the determined source device identifier is a particular source device identifier associated with the retail store based on the second association. In one configuration, the method 200 may include, in response to the determination that the determined source device identifier is the particular source device identifier associated with the retail store, increasing the confidence marker value. Alternatively or in addition to, the method 200 may include storing, by a memory device, a response matrix, wherein the response matrix identifies a plurality of UV responses corresponding to a plurality of confidence marker values and at least one of: a plurality of estimated locations of signal sources; a plurality of timestamps corresponding to receipts of signals, a plurality of source device identifiers, a plurality of data types, and a plurality network communication protocols source antenna. In one configuration, the method 200 may include, in response to the determination that the confidence marker value did not reach the second threshold, accessing the response matrix to determine a UV response of the plurality of UV responses operable by the UV. By one approach, the method 200 may include determining, via the access to the response matrix, the UV response corresponding to the confidence marker value and the estimated location of the signal source; the determined timestamp corresponding to the receipt, the determined source device identifier, the determined data type, and the receiving antenna source associated with the data communication. In yet some embodiments, the method 200 may include, in response to the determination that the data communication is hacked, initiating storage to the memory device of at least one of: the estimated location of the signal source; the determined timestamp corresponding to the receipt, the determined source device identifier, the determined data type, and the source antenna associated with the data communication to determine one or more patterns corresponding to hacked communication data over a period of time. In one configuration, the method 200 may include continuing operation of the transport device to move the UV through a predetermined route. By one approach, the predetermined route may be based on a mission data received by the UV 118 from the main control circuit 120.

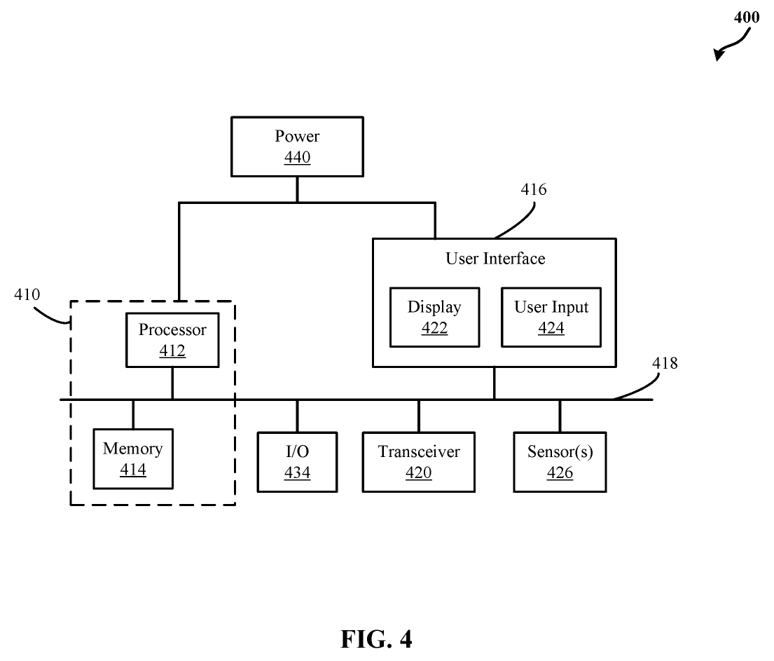

Further, the circuits, circuitry, systems, devices, processes, methods, techniques, functionality, services, servers, sources and the like described herein may be utilized, implemented and/or run on many different types of devices and/or systems. FIG. 4 illustrates an exemplary system 400 that may be used for implementing any of the components, circuits, circuitry, systems, functionality, apparatuses, processes, or devices of the system 100 of FIG. 1, the method 200 of FIG. 2, and/or other above or below mentioned systems or devices, or parts of such circuits, circuitry, functionality, systems, apparatuses, processes, or devices. For example, the system 400 may be used to implement some or all of the system 100 for identifying a hacked data communication received by an unmanned vehicle while delivering a purchased product, the control circuit 102, the memory device 104, the timing device 106, the transport device 108, the first antenna 110, the second antenna 112, the Nth antenna(s) 114, and/or other such components, circuitry, functionality and/or devices. However, the use of the system 400 or any portion thereof is certainly not required.

By way of example, the system 400 may comprise a processor module (or a control circuit) 412, memory 414, and one or more communication links, paths, buses or the like 418. Some embodiments may include one or more user interfaces 416, and/or one or more internal and/or external power sources or supplies 440. The control circuit 412 can be implemented through one or more processors, microprocessors, central processing unit, logic, local digital storage, firmware, software, and/or other control hardware and/or software, and may be used to execute or assist in executing the steps of the processes, methods, functionality and techniques described herein, and control various communications, decisions, programs, content, listings, services, interfaces, logging, reporting, etc. Further, in some embodiments, the control circuit 412 can be part of control circuitry and/or a control system 410, which may be implemented through one or more processors with access to one or more memory 414 that can store instructions, code and the like that is implemented by the control circuit and/or processors to implement intended functionality. In some applications, the control circuit and/or memory may be distributed over a communications network (e.g., LAN, WAN, Internet) providing distributed and/or redundant processing and functionality. Again, the system 400 may be used to implement one or more of the above or below, or parts of, components, circuits, systems, processes and the like. For example, the system 500 may implement the system for identifying a hacked data communication received by an unmanned vehicle while delivering a purchased product with the control circuit 102 being the control circuit 412.

The user interface 416 can allow a user to interact with the system 400 and receive information through the system. In some instances, the user interface 416 includes a display 422 and/or one or more user inputs 424, such as buttons, touch screen, trackball, keyboard, mouse, etc., which can be part of or wired or wirelessly coupled with the system 400. Typically, the system 400 further includes one or more communication interfaces, ports, transceivers 420 and the like allowing the system 400 to communicate over a communication bus, a distributed computer and/or communication network (e.g., a local area network (LAN), the Internet, wide area network (WAN), etc.), communication link 418, other networks or communication channels with other devices and/or other such communications or combination of two or more of such communication methods. Further, the transceiver 420 can be configured for wired, wireless, optical, fiber optical cable, satellite, or other such communication configurations or combinations of two or more of such communications. Some embodiments include one or more input/output (I/O) interface 434 that allow one or more devices to couple with the system 400. The I/O interface can be substantially any relevant port or combinations of ports, such as but not limited to USB, Ethernet, or other such ports. The I/O interface 434 can be configured to allow wired and/or wireless communication coupling to external components. For example, the I/O interface can provide wired communication and/or wireless communication (e.g., Wi-Fi, Bluetooth, cellular, RF, and/or other such wireless communication), and in some instances may include any known wired and/or wireless interfacing device, circuit and/or connecting device, such as but not limited to one or more transmitters, receivers, transceivers, or combination of two or more of such devices.

In some embodiments, the system may include one or more sensors 426 to provide information to the system and/or sensor information that is communicated to another component, such as the control circuit 102, the memory device 104, the timing device 106, the transport device 108, the first antenna 110, the second antenna 112, the Nth antenna(s) 114, etc. The sensors can include substantially any relevant sensor, such as temperature sensors, distance measurement sensors (e.g., optical units, sound/ultrasound units, etc.), optical based scanning sensors to sense and read optical patterns (e.g., barcodes), radio frequency identification (RFID) tag reader sensors capable of reading RFID tags in proximity to the sensor, and other such sensors. The foregoing examples are intended to be illustrative and are not intended to convey an exhaustive listing of all possible sensors. Instead, it will be understood that these teachings will accommodate sensing any of a wide variety of circumstances in a given application setting.

The system 400 comprises an example of a control and/or processor-based system with the control circuit 412. Again, the control circuit 412 can be implemented through one or more processors, controllers, central processing units, logic, software and the like. Further, in some implementations, the control circuit 412 may provide multiprocessor functionality.

The memory 414, which can be accessed by the control circuit 412, typically includes one or more processor readable and/or computer-readable media accessed by at least the control circuit 412, and can include volatile and/or nonvolatile media, such as RAM, ROM, EEPROM, flash memory and/or other memory technology. Further, the memory 414 is shown as internal to the control system 410; however, the memory 414 can be internal, external or a combination of internal and external memory. Similarly, some or all of the memory 414 can be internal, external or a combination of internal and external memory of the control circuit 412. The external memory can be substantially any relevant memory such as, but not limited to, solid-state storage devices or drives, hard drive, one or more of universal serial bus (USB) stick or drive, flash memory secure digital (SD) card, other memory cards, and other such memory or combinations of two or more of such memory, and some or all of the memory may be distributed at multiple locations over the computer network. The memory 414 can store code, software, executables, scripts, data, content, lists, programming, programs, log or history data, user information, customer information, product information, and the like. While FIG. 4 illustrates the various components being coupled together via a bus, it is understood that the various components may actually be coupled to the control circuit and/or one or more other components directly.

Those skilled in the art will recognize that a wide variety of other modifications, alterations, and combinations can also be made with respect to the above-described embodiments without departing from the scope of the invention, and that such modifications, alterations, and combinations are to be viewed as being within the ambit of the inventive concept.

What is claimed is:

1. A retail system for identifying a hacked data communication received by an unmanned vehicle while delivering a purchased product, comprising:
a retail unmanned vehicle (UV) comprising:
a first antenna configured to receive a first signal in accordance with a first network communication protocol;
a second antenna configured to receive a second signal in accordance with a second network communication protocol;
a timing device configured to provide a timestamp on the receipt of at least one of: the first signal and the second signal;
a memory device configured to store a first mission data associated with the UV;
a transport device configured to move the UV through a predetermined route based on the first mission data; and
a control circuit communicatively coupled to the first antenna, the second antenna, the timing device, the memory device, and the transport device, the control circuit configured to:
determine data communication and source antenna associated with the data communication based on at least one of: the first signal received by the first antenna and the second signal received by the second antenna, wherein the data communication corresponds to a demodulated signal of at least one of: the first signal and the second signal;
determine signal direction of at least one of: the first signal and the second signal based on corresponding signal strength;
estimate a location of a signal source of at least one of: the first signal and the second signal based on the determined signal direction;
determine, in cooperation with the timing device, the timestamp corresponding to the receipt of at least one of: the first signal and the second signal;
determine a source device identifier based on data content of the data communication;
determine data type of the data content;
determine whether the data communication is hacked based on at least: the estimated location of the signal source, the determined timestamp corresponding to the receipt, the determined source device identifier, the determined data type, and the source antenna; and
in response to the determination that the data communication is not hacked, modify the first mission data to a second mission data based on the data content; and
initiate operation of the transport device to move the UV through a modified route based on the second mission data.

2. The retail system of claim 1, wherein the first network communication protocol comprises Long Term Evolution (LTE), Wi-Fi, Bluetooth, WirelessHD, WiGig, Z-Wave, Zigbee, Local Area Network (LAN), and Wide Area Network (WAN).

3. The retail system of claim 1, wherein the second network communication protocol comprises Long Term Evolution (LTE), Wi-Fi, Bluetooth, WirelessHD, WiGig, Z-Wave, Zigbee, Local Area Network (LAN), and Wide Area Network (WAN), and wherein the second network communication protocol is distinct from the first network communication protocol.

4. The retail system of claim 1, wherein the memory device is further configured to store a confidence marker value and a plurality of associations comprising a first association of each of a plurality of neighborhood areas with one or more of a plurality of retail stores associated with the UV, a second association of each of a plurality of source device identifiers with one or more of the plurality of retail stores, a third association of each of the plurality of retail stores with one or more of a plurality of network communication protocols, and a fourth association of each of a plurality of data types with one or more of a plurality of time periods, and wherein the control circuit is further configured to:
determine whether the confidence marker value has reached a first threshold;
in response to the determination that the confidence marker value has reached the first threshold, determine that the data communication is not hacked; and
in response to the determination that the confidence marker value did not reach the first threshold, determine that the data communication is hacked.

5. The retail system of claim 4, wherein, in the estimation of the location of the signal source, the control circuit is further configured to:
determine a particular neighborhood area of the plurality of neighborhood areas the UV is currently located;
correlate the signal direction with the determined particular neighborhood area to estimate the location;
determine a confidence value that the estimated location corresponds to a retail store of the plurality of retail stores associated with the UV; and
in response to a determination that the confidence value has reached a second threshold, increase the confidence marker value.

6. The retail system of claim 4, wherein the control circuit is further configured to:
determine whether a particular network communication protocol of the plurality of network communication protocols corresponds to an expected communication protocol associated with the retail store based on the third association; and
in response to the determination that the particular network communication protocol corresponds to the expected communication protocol, increase the confidence marker value.

7. The retail system of claim 4, wherein the control circuit is further configured to:
determine whether the determined timestamp corresponding to the receipt is within a first time period of the plurality of time periods associated with the determined data type based on the fourth association; and
in response to the determination that the determined timestamp corresponding to the receipt is within the first time period, increase the confidence marker value.

8. The retail system of claim 4, wherein the control circuit is further configured to:
determine whether the determined source device identifier is a particular source device identifier associated with the retail store based on the second association; and
in response to the determination that the determined source device identifier is the particular source device identifier associated with the retail store, increase the confidence marker value.

9. The retail system of claim 4, wherein the memory device is further configured to store a response matrix, wherein the response matrix identifies a plurality of UV responses corresponding to a plurality of confidence marker values and at least one of: a plurality of estimated locations of signal sources; a plurality of timestamps corresponding to receipts of signals, a plurality of source device identifiers, a plurality of data types, and a plurality of network communication protocols associated with a source antenna, and wherein the control circuit is further configured to:
in response to the determination that the confidence marker value did not reach the first threshold, access the response matrix to determine a UV response of the plurality of UV responses operable by the UV; and
determine, via the access to the response matrix, the UV response corresponding to the confidence marker value and the estimated location of the signal source; the determined timestamp corresponding to the receipt, the determined source device identifier, the determined data type, and the receiving antenna source associated with the data communication.

10. The retail system of claim 1, wherein the control circuit is further configured to:
in response to the determination that the data communication is hacked, initiate storage to the memory device of at least one of: the estimated location of the signal source; the determined timestamp corresponding to the receipt, the determined source device identifier, the determined data type, and the source antenna associated with the data communication to determine one or more patterns corresponding to hacked communication data over a period of time; and
continue operation of the transport device to move the UV through the predetermined route.

11. A method for identifying a hacked data communication received by an unmanned vehicle while delivering a purchased product comprising:
determining data communication and source antenna associated with the data communication based on at least one of: first signal received by a first antenna of an unmanned vehicle (UV) and second signal received by a second antenna of the UV, wherein the first signal is associated with a first network communication protocol, wherein the second signal is associated with a second network communication protocol, and wherein the data communication corresponds to a demodulated signal of at least one of: the first signal and the second signal;
determining signal direction of at least one of: the first signal and the second signal based on corresponding signal strength;
estimating a location of a signal source of at least one of: the first signal and the second signal based on the determined signal direction;
determining, in cooperation with a timing device of the UV, a timestamp corresponding to receiving at least one of: the first signal and the second signal;
determining a source device identifier based on data content of the data communication;
determining data type of the data content;
determining whether the data communication is hacked based on at least: the estimated location of the signal source; the determined timestamp corresponding to the receipt of the at least one of: the first signal and the second signal, the determined source device identifier, the determined data type, and the source antenna; and
in response to the determination that the data communication is not hacked, modifying a first mission data stored in a memory device of the UV to a second mission data based on the data content; and
initiating operation of a transport device of the UV to move the UV through a modified route based on the second mission data.

12. The method of claim 11, wherein the first network communication protocol comprises Long Term Evolution (LTE), Wi-Fi, Bluetooth, WirelessHD, WiGig, Z-Wave, Zigbee, Local Area Network (LAN), and Wide Area Network (WAN).

13. The method of claim 11, wherein the second network communication protocol comprises Long Term Evolution (LTE), Wi-Fi, Bluetooth, WirelessHD, WiGig, Z-Wave, Zigbee, Local Area Network (LAN), and Wide Area Network (WAN), and wherein the second network communication protocol is distinct from the first network communication protocol.

14. The method of claim 11, further comprising:
storing, by the memory device, a confidence marker value and a plurality of associations comprising a first association of a plurality of neighborhood areas with a plurality of retail stores associated with the UV, a second association of a plurality of source device identifiers with the plurality of retail stores, a third association of the plurality of retail stores with a plurality of network communication protocols, and a fourth association of a plurality of data types with a plurality of time periods;
determining whether the confidence marker value has reached a first threshold;
in response to the determination that the confidence marker value has reached the first threshold, determining that the data communication is not hacked; and
in response to the determination that the confidence marker value did not reach the first threshold, determining that the data communication is hacked.

15. The method of claim 14, further comprising, in the estimating of the location of the signal source:
determining a particular neighborhood area of the plurality of neighborhood areas the UV is currently located;
correlating the determined signal direction with the determined particular neighborhood area to estimate the location;
determining a confidence value that the estimated location corresponds to a retail store of the plurality of retail stores associated with the UV; and
in response to a determination that the confidence value has reached a second threshold, increasing the confidence marker value.

16. The method of claim 14, further comprising:
determining whether a particular network communication protocol of the plurality of network communication protocols corresponds to an expected communication protocol associated with the retail store based on the third association; and
in response to the determination that the particular network communication protocol corresponds to the expected communication protocol, increasing the confidence marker value.

17. The method of claim 14, further comprising:
determining whether the determined timestamp corresponding to the receipt is within a first time period of the plurality of time periods associated with the determined data type based on the fourth association; and
in response to the determination that the determined timestamp corresponding to the receipt is within the first time period, increasing the confidence marker value.

18. The method of claim 14, further comprising:
determining whether the determined source device identifier is a particular source device identifier associated with the retail store based on the second association; and
in response to the determination that the determined source device identifier is the particular source device identifier associated with the retail store, increasing the confidence marker value.

19. The method of claim 14, further comprising:
storing, by the memory device, a response matrix, wherein the response matrix identifies a plurality of UV responses corresponding to a plurality of confidence marker values and at least one of: a plurality of estimated locations of signal sources; a plurality of timestamps corresponding to receipts of signals, a plurality of source device identifiers, a plurality of data types, and a plurality network communication protocols source antenna;
in response to the determination that the confidence marker value did not reach a second threshold, accessing the response matrix to determine a UV response of the plurality of UV responses operable by the UV; and
determining, via the access to the response matrix, the UV response corresponding to the confidence marker value and the estimated location of the signal source; the determined timestamp corresponding to the receipt of the at least one of: the first signal and the second signal, the determined source device identifier, the determined data type, and the antenna source associated with the data communication.

20. The method of claim 11, further comprising:
in response to the determination that the data communication is hacked, initiating storage to the memory device of at least one of: the estimated location of the signal source; the determined timestamp corresponding to the receipt, the determined source device identifier, the determined data type, and the source antenna associated with the data communication to determine one or more patterns corresponding to hacked communication data over a period of time; and
continuing operation of the transport device to move the UV through a predetermined route.
